(19) United States
(12) Patent Application Publication
(10) Pub. No.: US 2007/0290964 A1
(43) Pub. Date: Dec. 20, 2007

(54) FLAT PANEL DISPLAY SCAN SIGNAL COMPENSATION

(75) Inventor: YING-WEN YANG, Tainan County (TW)

Correspondence Address: FISH & RICHARDSON PC, P.O. BOX 1022, MINNEAPOLIS, MN, 55440-1022, US

(73) Assignee: Chi Mei Optoelectronics Corporation, Tainan County (TW)

(21) Appl. No.: 11/735,649

(22) Filed: Apr. 16, 2007

(30) Foreign Application Priority Data
Apr. 17, 2006 (TW) 95113700

(51) Int. Cl. G09G 3/36

(52) U.S. Cl. 345/87

(57) ABSTRACT

An apparatus includes a display panel having pixels, and a timing controller that uses a frame rate control look-up table to generate more gray scale levels than available from a data driver. The timing controller uses the increased number of gray scale levels to compensate distortions in luminance across the display panel due to decreases in signal strengths of scan signals transmitted on scan lines of the display panel.

### CROSS REFERENCE TO RELATED APPLICATIONS

The application claims priority to Taiwan Application No. 95113700, filed Apr. 17, 2006, the contents of which are incorporated by reference.

### BACKGROUND

This document relates to flat panel display scan signal compensation.

FIG. 1 is a diagram of an example of a conventional liquid crystal display (LCD) panel that includes a data driver 10, a scan driver 20, a plurality of pixels (e.g., 13), a plurality of scan lines (e.g., 20a-20m), and a plurality of data lines (e.g., 16a-16n). Each pixel is controlled by a corresponding data line and a scan line. For example, the data line 16a and the scan line 20b control the pixel 13 that includes a transistor 12ba and a capacitor 14ba. The scan line 20b is coupled to a gate of the transistor 12ba for transmitting a scan signal to turn on or off the transistor 12ba. the data line 16a is coupled to a drain of the transistor 12ba for transmitting a data signal from the data driver 10 according to image data. When the scan driver 20 sends a scan signal to turn on the transistors of a row of pixels, the data driver 10 transmits image data signals to the pixels through the data lines 16a-16n. Resistor-capacitor (RC) effects of the scan lines 20a, 20b, . . . , and 20m may degrade signals transmitted by scan lines.

FIG. 2 is a diagram of an example of an image shown on a conventional LCD panel, in which the image has horizontal luminance non-uniformity due to scan signal distortion. For example, when a scan signal is transmitted through the scan line 20b, the scan signal is distorted due to the RC effect of the scan line 20b, causing different turn-on time intervals for the transistors 12ba, . . . 12bn, such as time intervals T1, T2 and T3 shown in FIG. 2. the horizontal luminance of the LCD panel is different when the driving voltage levels of the data signals transmitted through the data lines 16a, 16b . . . and 16n are equal.

In some examples, horizontal luminance uniformity of the LCD panel can be improved by increasing the width of the scan lines to reduce the resistance of the scan lines. this may increase the capacitances of the scan lines, and the aperture ratio of LCD panel may be decreased. In some examples, the horizontal luminance uniformity of the LCD panel can be improved by increasing the thickness of scan lines. The maximum thickness of the scan lines is limited. This may also increase the production cost. In some examples, a double-sided driving method is used in a large-sized LCD panel to reduce the RC effect. The production cost may increase because two sets of driving components are used.

In some examples, the luminance uniformity can be improved by providing different driving voltage levels, e.g., V1, V2, V3, etc., to the data signals transmitted through the data lines, e.g., 16a, 16b, . . . , and 16n.

Referring to FIG. 3a, if the scan lines are ideal and the scan signals are not distorted due to the RC effects of the scan lines, the luminance of the LCD panel changes from left to right because the data signals applied to the data lines have different voltage levels (e.g., V1-V3). For example, when the driving voltage level increases from left to right of the LCD panel. the luminance of the LCD panel increases from left to right.

Referring to FIG. 3b, when the scan signals are distorted due to the RC effects of the scan lines, the distortion of the scan signals can be compensated by sequentially increasing the driving voltage levels, e.g., V1, V2, V3, etc., of the data signals transmitted through the data lines, e.g., 16a, 16b, . . . , and 16n. When the image data represent an image having a uniform luminance across the display, the data voltages applied to the data lines gradually increases from 16a to 16n. Although the turn-on time intervals for the transistors gradually decrease from 12ba to 12bn due to the RC effect, the total amount of charge stored in the capacitor of each of the pixels is substantially the same (e.g., using a higher voltage to charge a capacitor for a shorter period of time may result in the same amount of charge as using a lower voltage to charge the capacitor for a longer period of time), resulting in substantially uniform luminance when the image data correspond to an image having uniform luminance.

In order to increase the driving voltage level sequentially for different data lines to improve the luminance uniformity, data drivers having high voltage resolutions may be used. For example, for an LCD panel that uses 8-bit data drivers, if 2 bits are used for luminance compensation, four different voltage levels can be used to compensate luminance non-uniformity across the display. This may result in four bands appearing on the display, each band having luminance that varies within the band. Using data drivers having higher voltage resolutions can provide more voltage levels and a better gray level gradation. Data drivers having higher resolution may also increase the cost of the display.

### SUMMARY

In one aspect, in general, a display includes a display panel having pixels, and a timing controller to use a frame rate control look-up table to generate more gray scale levels than available from a data driver. The timing controller uses the increased number of gray scale levels to compensate distortions in luminance across the display panel due to decreases in signal strengths of scan signals transmitted on scan lines of the display panel.

Implementations of the display may include one or more of the following features. The display includes a plurality of frame rate control look-up tables each for use in generating gray scale levels for compensating pixels located at a portion of the display panel.

In another aspect, in general, a display includes a display panel having pixels, and a timing controller to selectively apply an over-drive control look-up table and a frame rate control look-up table to pixel data based on whether the pixel data correspond to a portion of a motion image or a portion of a still image, respectively. The timing controller uses the frame rate control look-up table to generate more gray scale levels than available from a data driver. The timing controller uses the frame rate control look-up table to compensate distortions in luminance across the display panel due to decreases in signal strengths of scan signals transmitted on scan lines of the display panel.

In another aspect, in general, a method of operating a display includes compensating distortions in luminance across the display due to decreases in signal strengths of scan signals transmitted on scan lines of the display by using frame rate control to generate more gray scale levels than available from a data driver, and using the increased number of gray levels to compensate the distortions in luminance.

Implementations of the method may include one or more of the following features. Using frame rate control includes generating three gray levels in three pixels by switching each pixel between a first gray level and a second gray level, different pixels showing the first gray level for different percentages of time. Compensating the distortions in luminance includes applying a smaller amount of compensation to pixels closer a scan driver and applying a larger amount of compensation to pixels farther away from the scan driver, the scan driver generating the scan signals.

In another aspect, in general, a method or a circuit for compensating scan signal loss of a LCD panel is provided. The linear luminance decrement of the LCD panel from left to right due to transmission line signal loss can be compensated by using a frame rate control technique and a frame rate control look-up table, improving the luminance uniformity of the LCD panel.

In another aspect, in general, a method or a circuit for compensating scan signal lass of a LCD panel is provided, in which the compensation circuit for scan signal loss includes a frame rate control look-up table and an overdrive control look-up table. A comparator compares image data of a current frame to the image data of a previous frame stored in a frame buffer. the comparator determines whether pixels correspond to portions of a still image or a motion image according to the comparison. When the pixels correspond to portions of a still image, the luminance of the pixels is compensated by using the frame rate control look-up table, reducing luminance non-uniformity due to scan line signal loss. When the pixels correspond to portions of a motion image, the luminance of the pixels is compensated using the overdrive control look-up table to reduce image blurring.

In another aspect, in general, a method or a circuit for compensating scan signal loss of a LCD panel is provided, in which the compensation circuit for scan signal loss includes a frame rate control look-up table and an overdrive control look-up table. Based on a comparison of a current frame and a previous frame stored in a frame buffer, pixels in the current frame are identified as being either portions of a still image or portions of a motion image, and a corresponding look-up table is used for luminance compensation to change driving voltage levels for driving the pixels.

In another aspect, in general, an LCD panel having a compensation circuit for compensating scan signal loss includes a frame buffer for storing a first frame of an image data and a timing controller for receiving a second frame of the image data. The timing controller includes a comparator coupled to the frame buffer, in which the comparator compares the first frame of the image data and the second frame of the image data. The timing controller includes a counter for providing a pixel location of the second frame of the image data, and a look-up table coupled to the comparator and the counter. The look-up table including a frame rate control look-up table that has a plurality of frame tables, each table including different luminance values. The luminance of the second frame is compensated based on a comparison result provided by the comparator and the frame tables.

The disclosed displays and techniques may provided one or more of the following advantages. A large size display can have a uniform luminance even when there is signal loss on scan lines due to the long lengths of the scan lines and/or the resistor-capacitor effects of the scan lines. The cost of the large size display can be reduced by using single-sided driving instead of double-sided driving. More shades of gray can be generated using frame rate control that the gray levels available from data drivers, thereby allowing a smoother transition in luminance between segments of the display.

The details of one or more implementations are set forth in the accompanying drawings and the description below. Other features, aspects, and advantages will be apparent from the description and drawings, and from the claims.

### DESCRIPTION OF DRAWINGS

FIG. 1 is a schematic diagram of an LCD panel.

FIG. 2 is a diagram of an image shown on an LCD panel and corresponding transistor turn-on time periods.

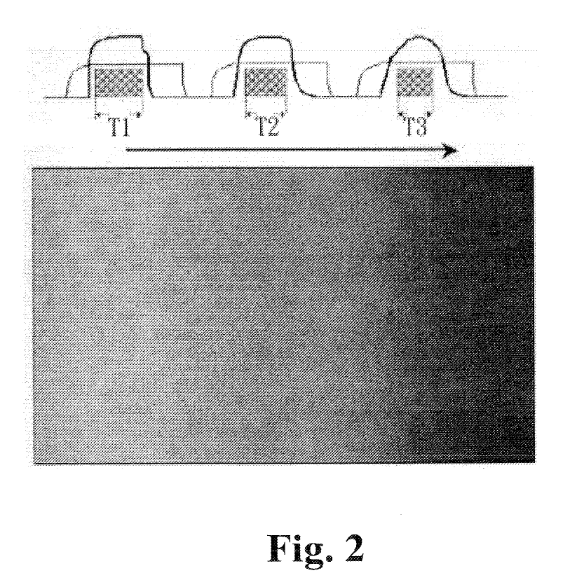

FIGS. 3a and 3b are diagrams of images shown on an LCD panel and corresponding data voltage levels.

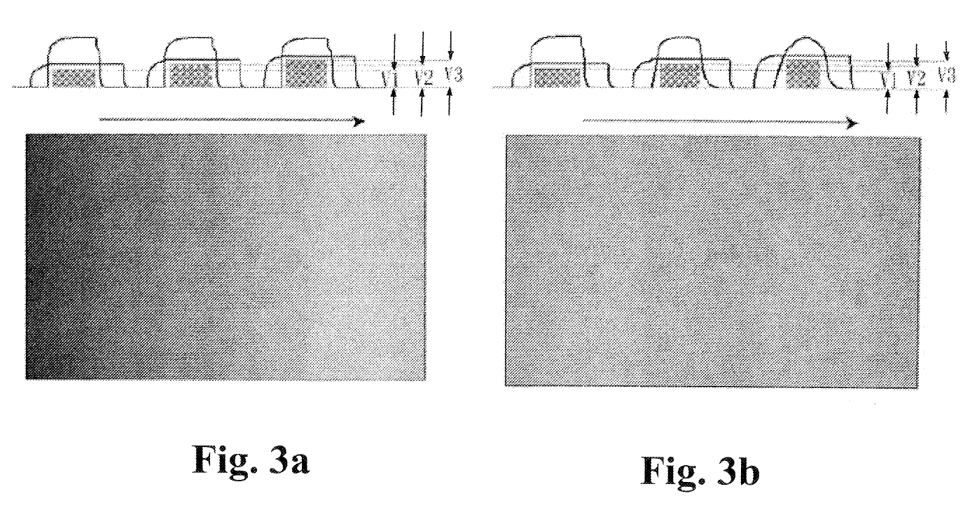

FIG. 4 is a schematic diagram of a display.

FIG. 5 is a diagram showing look-up tables applied to different portions of an image.

FIGS. 6a-6b are diagrams of images shown on a display and corresponding look-up tables.

FIGS. 7a and 7c show diagrams of 8-bit look-up tables.

FIGS. 7b and 7d are diagrams showing horizontal luminance changes across a display.

FIGS. 8a and 8b are diagrams of 8-bit and 6-bit look-up tables, respectively.

### DETAILED DESCRIPTION

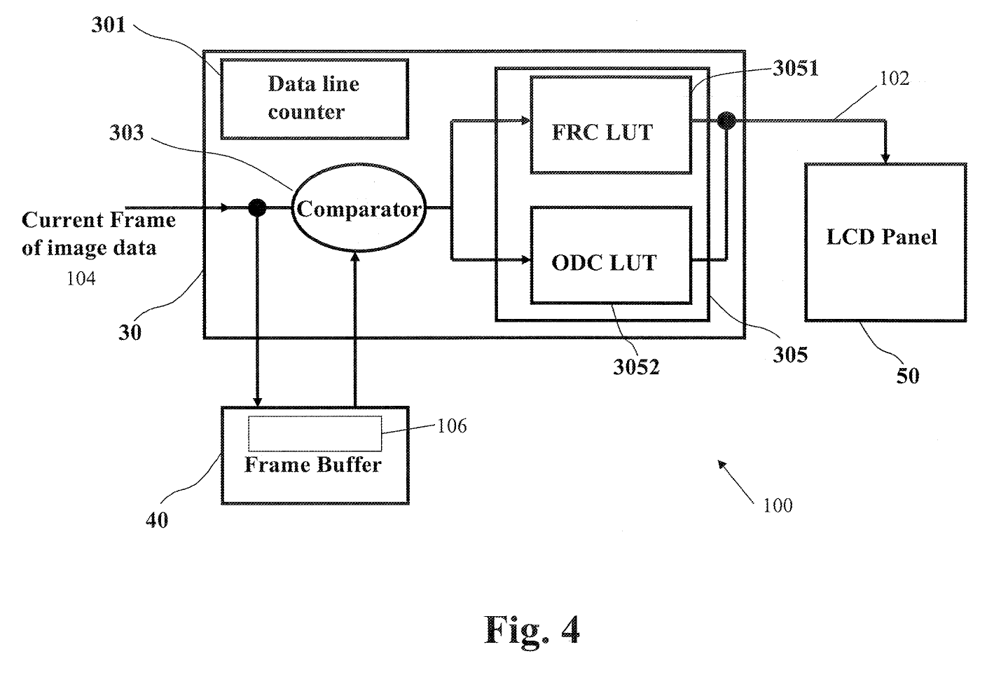

FIG. 4 is a schematic diagram of a display 100 that compensates scan line signal losses by applying smaller amounts of compensation to pixels closer to scan drivers and applying larger amounts of compensation to pixels farther away from the scan drivers. By using a frame rate control technique, a larger number of gray levels than the number of voltage levels provided by the data drivers can be generated. For example, a pixel can switch between a first gray level and a second gray level over several frame periods so that the pixel is perceived by a viewer as having a gray level between the first and second gray levels. By using different ratios of frame period(s) having the first gray level and frame period(s) having the second gray level, different shades of gray between the first and second gray levels can be generated. A large number of gray levels can be used in compensating luminance non-uniformity due to scan line signal loss to achieve a uniform luminance across the display 100.

The display 100 can be, e.g., a flat display, such as a liquid crystal display. The display 100 includes a timing controller 30, a frame buffer 40, and an LCD panel 50. The timing controller 30 includes a data line counter 301, a scan counter (not shown), a comparator 303 and a look-up table 305. The timing controller 30 includes a frame rate control (FRC) look-up table (LUT) 3051 and an over-drive control (ODC) look-up table 3052. The over-drive control look-up table 3052 is used for pixels that show portions of motion images (e.g., video or animation). The frame rate control look-up table 3051 is used for pixels that show portions of still images. The timing controller 30 determines whether pixels are showing portions of still images or motion images by using a comparator 303 to compare a current frame 104 of image data to a previous frame 106 of image data stored in a frame buffer 40 to identify changes from the previous frame 106 to the current frame 104.

When the pixels show portions of still images, the display 100 uses the frame rate control look-up table 3051 to compensate the luminance non-uniformity caused by signal losses due to the RC effects of the scan lines. When the pixels show portions of motion images, the non-uniformity in luminance is less significant to the viewer than the blurring of images that occur when, e.g., liquid crystal cells do not switch fast enough. The display 100 uses the over-drive control look-up table 3052 to reduce the blurring of images when motion images are shown. The display 100 may use different look-up tables (3051 or 3052) for different pixels of the same frame because an image may have both still image portions and motion image portions (e.g., a moving ball in front of a still background).

The pixel data that are obtained after applying look-up tables 3051 and 3052 are referred to as “compensated pixel data,” and are sent to the LCD panel 50 through a signal line 102. By providing the compensated pixel data to the pixels of the LCD panel 50, the LCD panel 50 can show motion images having reduced blurring and still images having more accurate luminance values (e.g., luminance values that are not distorted due to scan line signal losses).

The purpose of using the frame rate control look-up table 3051 is to enable the LCD panel 50 to show images with accurate luminance values, regardless of whether the image has uniform luminance across the image or has luminance values that vary among different portions of the image.

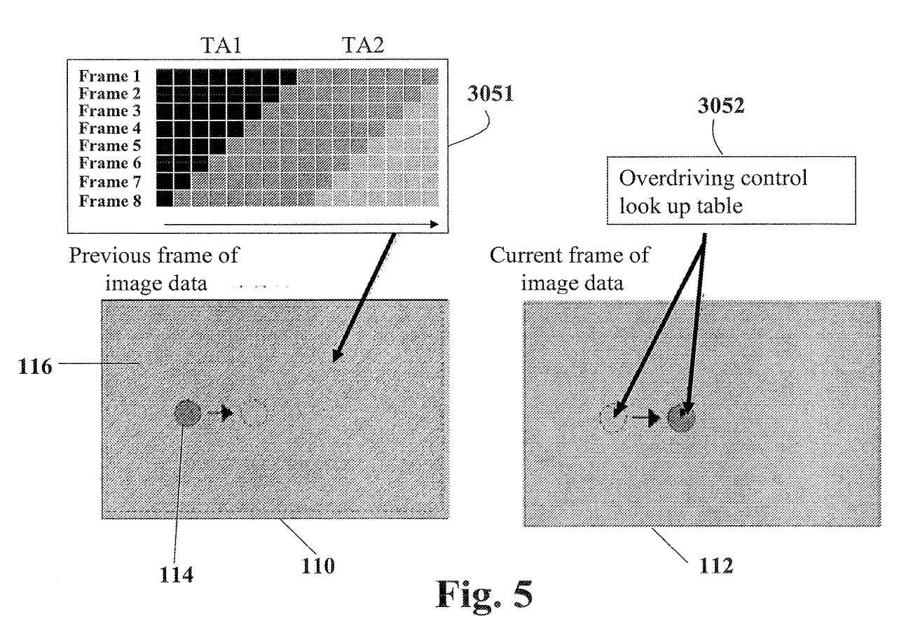

FIG. 5 is a diagram showing different look-up tables applied to different portions of an image. On the left of the figure is a previous frame 110 that has a ball 114 on a still background 116. On the right of the figure is a current frame 112 in which the ball 114 has moved a distance towards the right. In this example, for pixels of the still background 116, the frame rate control look-up table 3051 is used to determine the compensated pixel data. for the pixels of the ball 114, the over-drive control look-up table 3052 is used to determine the compensated pixel data.

The frame rate control look-up table 3051 in FIG. 5 includes two tables, TA1 and TA2. The diagram in FIG. 5 shows how the gray scale levels of pixels vary from one frame to another when the look-up table TA1 or TA2 is applied to the pixels. The diagram shows pixel values for eight consecutive frames (e.g., Frame 1 to Frame 8).

For example, when the look-up table TA1 is used to determine the luminance values of 8 consecutive pixels, in Frame 1, all 8 pixels have the same gray scale level, e.g., black. In Frame 2, 7 pixels are black and 1 pixel is dark gray. In Frame 3, 6 pixels are black and 2 pixels are dark gray. In Frame 8, 1 pixel is black and 7 pixels are dark gray, and so forth.

In this example, pixel 1 shows black for 8 frames. Pixel 2 shows black for 7 frames and dark gray for 1 frame. Pixel 3 shows black for 6 frames and dark gray for 2 frames. Pixel 8 shows black for 1 frame and dark gray for 7 frames, and so forth. Over time, pixels 1 to 8 appear to have eight different gray scale levels, ranging from black to dark gray.

For example, when the look-up table TA2 is used to determine the luminance values of 8 consecutive pixels, in Frame 1, all of the 8 pixels are dark gray. In Frame 2, 7 pixels are dark gray and 1 pixel is light gray. In Frame 3, 6 pixels are dark gray and 2 pixels are light gray. In Frame 8, 1 pixel is dark gray and 7 pixels are light gray, and so forth.

In this example, pixel 1 shows dark gray for 8 frames. Pixel 2 shows dark gray for 7 frames and light gray for 1 frame. Pixel 3 shows dark gray for 6 frames and light gray for 2 frames. Pixel 8 shows dark gray for 1 frame and light gray for 7 frames, and so forth. Over time, pixels 1 to 8 appear to have eight different gray scale levels, ranging from dark gray to light gray.

The comparator 303 (FIG. 4) compares pixels of the current frame to those of the previous frame to determine which pixels correspond to still image portions and which pixels correspond to motion image portions. When the comparator 303 determines that a pixel of the current frame corresponds to a still image portion, the data line counter 301 and the scan counter provide the location of the pixel, and the over-drive control look-up table 3051 is used to compensate the distortion of luminance of the pixel due to scan line signal loss. When the comparator 303 determines that a pixel of the current frame correspond to a motion image portion, the data line 301 and the scan counter provide the location of the pixel, and the over-drive control look-up table 3052 is used to adjust the pixel data to reduce image blurring.

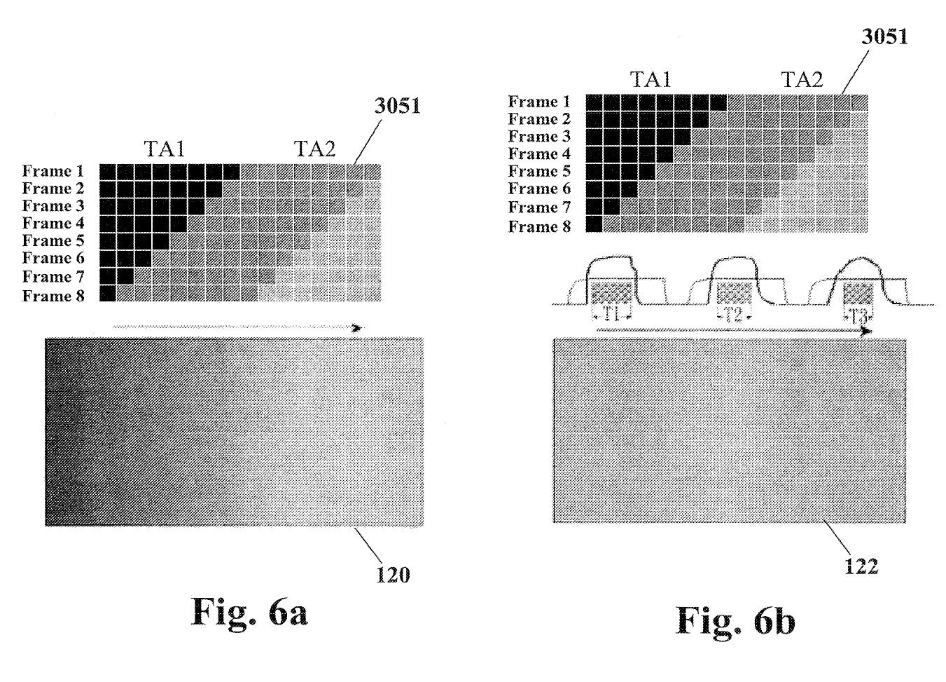

FIG. 6a shows a diagram of an image 120 that is obtained by applying the frame rate control look-up table 3051 to an ideal display panel in which the signals transmitted on ideal scan lines maintain the same levels for the entire lengths of the scan lines. When a still image having uniform luminance is provided to the display panel and the frame rate control look-up table 3051 is used to adjust the pixel data, the luminance of pixels on the display panel increases from left to right.

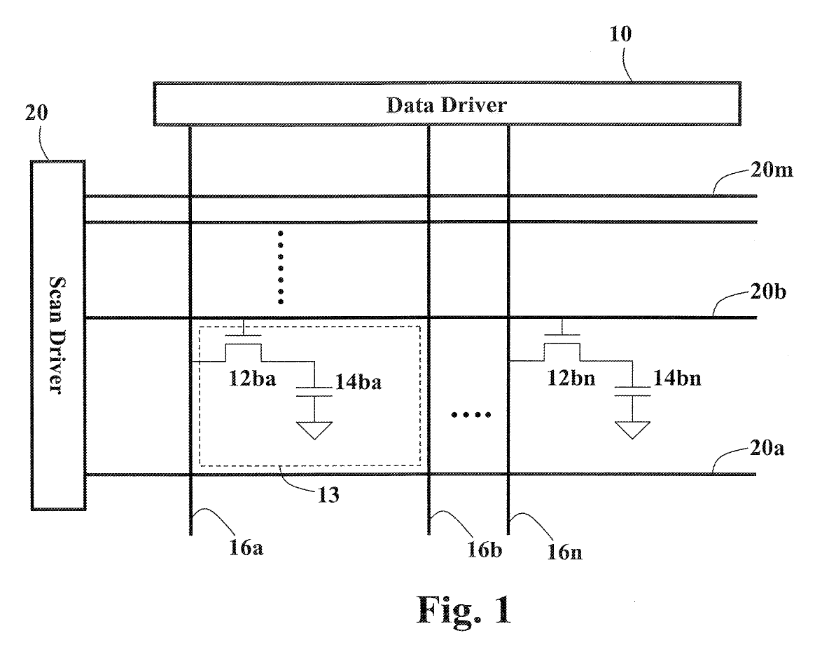

Referring to FIG. 6b, for a large size LCD panel 50 in which the signal level on the scan line decreases (e.g., due to RC effect) as the signal traverses farther along the scan line, the durations (e.g., T1, T2, T3) for which the transistors (e.g., 12ba to 12bn of FIG. 1) of the pixels are turned on decrease from left to right of the LCD panel 50. Without compensation, the luminance would decrease from left to right of the LCD panel 50.

FIG. 6b shoes a diagram of an image 122 that is obtained by applying the frame rate control look-up table 3051 to a display panel in which the signals transmitted on scan lines decrease in voltage levels as the signals travel along the lengths of the scan lines. The image 122 has a uniform luminance across the entire image. This indicated that the increase in luminance from left to right of the LCD panel 50 caused by applying the frame rate control look-up table 3051 compensates the decrease in luminance from left to right of the panel 50 due to scan line signal loss, resulting in an image having a uniform luminance.

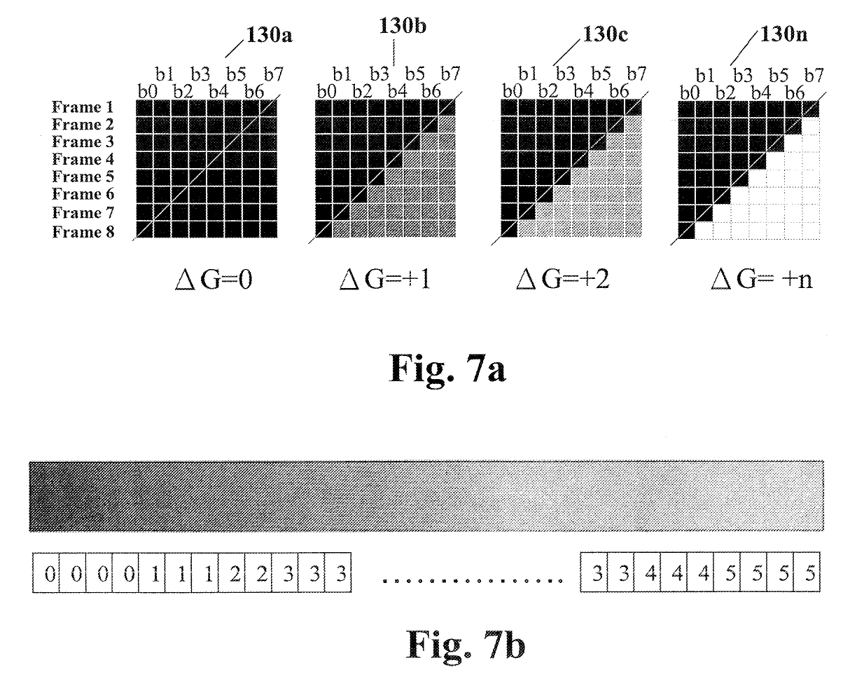

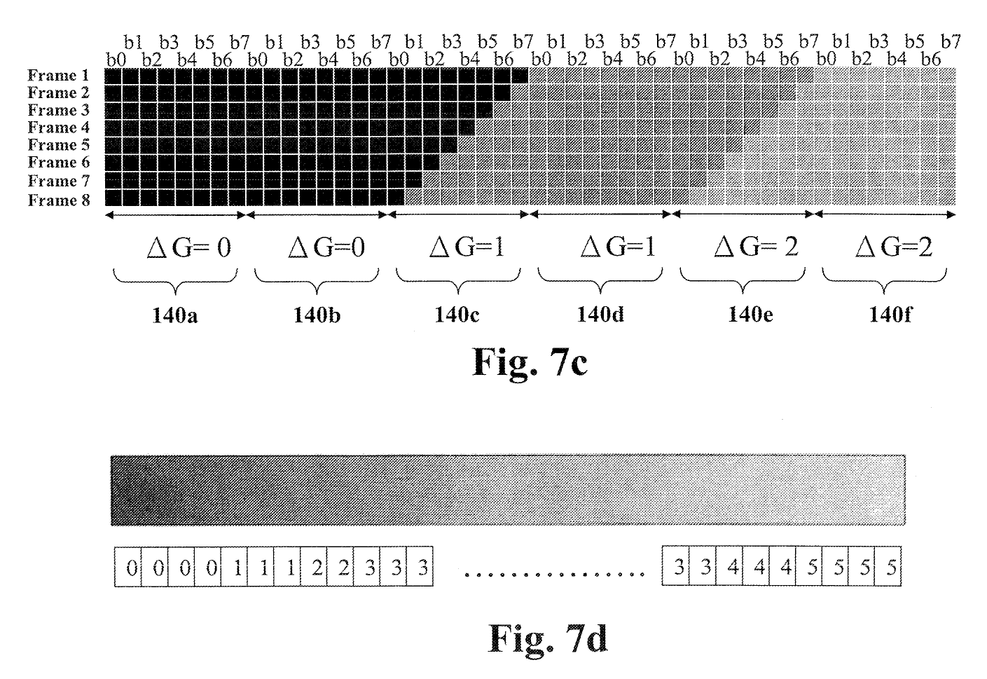

FIG. 7a shows diagrams of an example of a series of 8-bit frame rate control look-up tables (130a to 130n) that correspond to different ΔG reference values. Each table (e.g., 130a to 130n) includes information about the gray scale levels of 8 consecutive pixels (represented by 8 bits) for 8 successive frames, including Frame 1 to Frame 8. The pixels in the upper-left region of each table have the same gray scale level, and the pixels in the lower-right region of the table have the same gray scale level. The luminance difference between the upper-left and lower-right regions depends on the reference value ΔG.

For example, when ΔG=0, a frame rate control look-up table 130a is configured such that the 8 pixels have the same gray scale levels for Frames 1 to 8.

When ΔG=+1, a frame rate control look-up table 130b is configured such that the 8 pixels are black during Frame 1, 7 pixels are black and 1 pixel is dark gray in Frame 2, 6 pixels are black and 2 pixels are dark gray in Frame 3, and 1 pixel is black and 7 pixels are dark gray in Frame 8, and so forth. Over time, the 8 pixels show 8 different gray scale levels ranging from black to dark gray, in which the gray scale levels of pixels 1 to 8 change linearly from black to dark gray.

When ΔG=+2, a frame rate control look-up table 130c is configured such that the 8 pixels are dark gray during Frame 1, 7 pixels are black and 1 pixel is light gray in Frame 2, 6 pixels are black and 2 pixels are light gray in Frame 3, and 1 pixel is black and 7 pixels are light gray in Frame 8, and so forth. Over time, the 8 pixels show 8 different gray scale levels ranging from black to light gray, in which the gray scale levels of pixels 1 to 8 change linearly from dark gray to light gray.

When ΔG=+n a frame rate control look-up table 130n is configured such that the 8 pixels are black during Frame 1, 7 pixels are black and 1 pixel is white in Frame 2, 6 pixels are black and 2 pixels are white in Frame 3, and 1 pixel is black and 7 pixels are white in Frame 8, and so forth. Over time, the 8 pixels show 8 different gray scale levels ranging from black to white, in which the gray scale levels of pixels 1 to 8 change linearly from black to white.

Note the reference value ΔG can be either positive or negative, and the gray scale levels in the look-up tables can have values different from those described above.

FIG. 7b shows that different ΔG reference values can be used for pixels at different regions of the LCD panel 50. For pixels at the left of the LCD panel 50, the reference value ΔG=0. For pixels at the right of the LCD panel 50, the reference value ΔG=5. As the pixels move from the left to the right of the LCD panel 50, the reference value ΔG changes from 0 to 5. The gray scale values in the look-up tables (e.g., 130a to 130n) depend on the luminance difference between the left and right portions of the LCD panel 50.

FIG. 7c shows diagrams of another example of a series of 8-bit frame rate control look-up tables (140a to 140f) that correspond to different ΔG reference values. Each look-up table in FIG. 7c includes information about the gray scale levels of 8 consecutive pixels (represented by 8 bits) for 8 successive frames, including Frames 1 to 8.

For example, the frame rate control look-up tables 140a and 140b are configured such that, when the look-up tables are applied to 8 pixels, the 8 pixels all show the same gray scale level (e.g., black) for Frames 1 to 8.

The frame rate control look-up table 140c is configured such that, when the look-up table 140c is applied to 8 pixels, over time, the 8 pixels show 8 different gray scale levels ranging from, e.g., black to dark gray, similar to the look-up table 130b of FIG. 7a. The 8 pixels have gray scale levels that change linearly from black to dark gray.

The frame rate control look-up table 140d is configured such that, when the look-up table 140c is applied to 8 pixels, the 8 pixels all show the same gray scale level, e.g., dark gray.

The frame rate control look-up table 140e is configured such that, when the look-up table 140e is applied to 8 pixels, over time, the 8 pixels show 8 different gray scale levels ranging from, e.g., dark gray to light gray. The 8 pixels have gray scale levels that change linearly from dark gray to light gray.

The frame rate control look-up table 140f is configured such that, when the look-up table 140f is applied to 8 pixels, the 8 pixels all show the same gray scale level, e.g., light gray.

By applying the frame rate control look-up tables 140a to 140f to 48 pixels, the 32 pixels show, e.g., black, several shades of gray between black and dark gray, dark gray, several shades of gray between dark gray and light gray, and light gray, resulting in a smooth transition in luminance from black to light gray across the 48 pixels.

Similar to FIG. 7b, FIG. 7d shows that different ΔG reference values can be used for pixels at different regions of the LCD panel 50. For pixels at the left of the LCD panel 50, the reference value ΔG=0. For pixels at the right of the LCD panel 50, the reference value ΔG=5. As pixels move from the left to the right of the LCD panel 50, the reference value ΔG changes from 0 to 5. The gray scale values in the look-up tables (e.g., 140a to 140f) depend on the luminance difference between the left and right portions of the LCD panel 50. The reference value ΔG can be set to have values different from those described above.

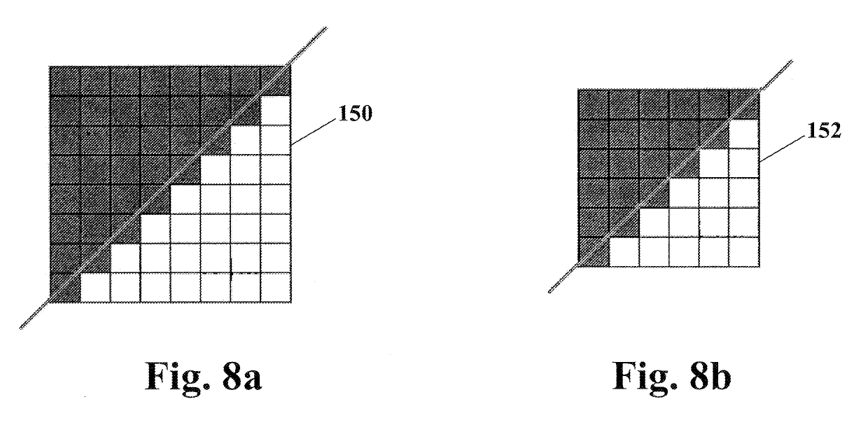

FIG. 8a is a diagram of an example on an 8-bit frame rate control look-up table 150. FIG. 8b is a diagram of an example of a 6-bit frame rate control look-up table 152. the number of rows of the frame rate control look-up table corresponds to the number of frames that have different gray scale levels, which in turn corresponds to the number of different gray scale levels that can be generated by using the look-up table. The larger the number of rows in the look-up table, the larger the number of different gray scale levels that can be generated using the frame rate control technique. The gray scale values in the look-up table depend on the luminance difference between the left and right portions of the LCD panel 50.

Referring to FIGS. 4, 6a, and 6b, the display 100 includes a frame rate control look-up table 3051 having information about the gray scale levels of 8 consecutive pixels for 8 successive frames. The current frame is received by the timing controller 30, which includes the comparator 303 that compares the current frame and the previous frame. When the comparator 303 determines that a pixel in the current frame corresponds to a portion of a still image, the gray scale value of the pixel is compensated. The amount of compensation increases linearly as the pixel's location changes from left to right of the LCD panel 50. The compensation is performed be applying look-up tables, such as look-up tables TA1 and TA2, to the pixels, in which the gray scale levels of the look-up tables increase linearly as the positions of the pixels change from left to right of the LCD panel 50. This reduces luminance non-uniformity of the LCD panel 50 due to scan line signal loss, with smooth transitions in luminance levels between segments of the display.

When the frame rate control technique is used the compensate luminance non-uniformity in still images, the number of frames in each look-up table affects the resolution of the frame rate control technique. The horizontal lines of the LCD panel 50 can be divided into a plurality of segments according to the number of frames in the look-up tables. Different look-up tables are used for compensating luminance variations at different segments.

For example, assume that the LCD panel 50 has a resolution of 1920×1080 pixels, and each look-up table is used to compensate the luminance values of 8 consecutive pixels. A horizontal line of the LCD panel 50 is divided into 1920/8=240 segments, and 240 frame rate control look-up tables are generated. The gray scale level values of the 240 look-up tables may be determined based on the ΔG reference values, as described above for FIGS. 7a to 7d.

Some of the look-up tables can be used to generate several gray scale levels between a first gray scale level and a second gray scale level provided by the data driver. For example, the pixels in the upper-left region of a look-up table can have a first gray scale value, and the pixels in the lower-right region of the look-up table can have a second gray scale value. The look-up table can be used to generate 8 different gray scale levels ranging from the first gray scale level to the second gray scale level.

When the 240 look-up tables are placed adjacent to one another, similar to the look-up tables shown in FIG. 7c, the pixels in the lower-right region of a look-up table and the pixels in the upper-left region of the next look-up table may have the same gray scale level. Similarly, the pixels in the upper-left region of the look-up table and the pixels in the lower-right region of the previous look-up table may have the same luminance value. The luminance resolution (i.e., the number of luminance levels or gray scale levels) is determined by the length of the frame rate control look-up table. By using frame rate control, the luminance changes linearly from one segment of the LCD panel 50 to the next segment.

Referring to FIGS. 8a and 8b, assume that the resolution of the LCD panel 50 is 1920×1080 pixels. When a 8-bit look-up table (which has data for 8 pixels per frame) is used, the horizontal line of the LCD panel 50 can be divided into 1920/8=240 segments. A total of 240 look-up tables each storing relevant gray scale values can be used to compensate luminance non-uniformity across the LCD panel 50. When a 6-bit look-up table (which as data for 6 pixels per frame) is use, the horizontal line of the LCD panel 50 can be divided into 1920/6=320 segments. A total of 320 look-up tables each storing relevant gray scale values can be used to compensate luminance non-uniformity across the LCD panel 50.

Although some implementations have been discussed above, other implementations and applications are also within the scope of the following claims. For example, the values of various parameters, such as the reference value ΔG, the gray scale values in the look-up tables, the display resolution, the number of frames per look-up table, the number of pixels per look-up table, the number of look-up tables for each display, can be different from those described above. The techniques for compensating scan line signal loss are not limited to liquid crystal displays, and may also be used in other types of flat panel displays that have scan lines. The display can use the frame rate control look-up table without using the over-drive control look-up table. The frame rate control look-up tables can be configured such that the gray scale level changes in a non-linear manner from the first pixel to the last pixel. The frame rate control look-up tables con be configured such that the gray scale levels changes from brighter to darker as pixels move from left to right in position. For example, such look-up tables can be used in displays in which the scan drivers are placed at the right side of the display.

What is claimed is:

1. An apparatus comprising:
a display panel comprising pixels;
a timing controller to use a frame rate control look-up table to generate more gray scale levels than available from a data driver, and use the increased number of gray scale levels to compensate distortions in luminance across the display panel due to decreases in signal strengths of scan signals transmitted on scan lines of the display panel.

2. The display of claim 1, further comprising a plurality of frame rate control look-up tables each for use in generating gray scale levels for compensating pixels located at a portion of the display panel.

3. An apparatus comprising:
a display panel comprising pixels;
a timing controller to selectively apply an over-drive control look-up table and a frame rate control look-up table to pixel data based on whether the pixel data correspond to a portion of a motion image or a portion of a still image, respectively.

4. The apparatus of claim 3 wherein the timing controller uses the frame rate control look-up table to generate more gray scale levels than available from a data driver.

5. The apparatus of claim 3 wherein the timing controller uses the frame rate control look-up table to compensate distortions in luminance across the display due to decreases in signal strengths of scan signals transmitted on scan lines of the display panel.

6. A method comprising:
compensating distortions in luminance across a display due to decreases in signal strengths of scan signals transmitted on scan lines of the display by using frame rate control to generate more gray scale levels that available from a data driver, and using the increased number of gray scale levels to compensate the distortions in luminance.

7. The method of claim 6 wherein using frame rate control comprises generating three gray levels in three pixels by switching each pixel between a first gray level and a second gray level, different pixels showing the first gray level for a different percentage of time.

8. The method of claim 6 wherein compensating the distortions in luminance comprises applying a smaller amount of compensation to pixels closer to a scan driver and applying a larger amount of compensation to pixels farther away from the scan driver, the scan driver generating the scan signals.

9. A liquid crystal display panel comprising:
a plurality of data lines;
a plurality of scan line;
a plurality of pixels, each corresponding to one of the data lines and one of the scan lines;
a data driver coupled to the data lines;
a scan driver coupled to the scan lines; and
a timing controller for compensating scan signal loss of the liquid crystal display panel, comprising:
a comparator for comparing a first frame of image data and a second frame of the image data;
a counter for providing a pixel location of the second frame of the image data; and
a look-up table coupled to the comparator and the counter, the look-up table comprising a frame rate control look-up table having a plurality of frame tables, different frame tables having different luminance values, wherein the luminance of the second frame is compensated based on the frame tables and the comparison result of the comparator.

10. The liquid crystal display panel of claim 9, wherein the first frame comprises a previous frame.

11. The liquid crystal display panel of claim 10, wherein the second frame comprises a current frame.

12. The liquid crystal display panel of claim 11, wherein the counter comprises a data line counter for counting a current pixel location among the data lines.

13. The liquid crystal display panel of claim 12, wherein when the second frame is determined to be a still image according to the comparison result of the comparator, the luminance of the second frame is compensated with the pixel location of the second frame of the image data and the frame rate control look-up table, reducing luminance non-uniformity due to transmission line signal loss.

14. The liquid crystal display panel of claim 13, wherein the look-up table further comprises an over-drive control look-up table for improving image sticking when the second frame is determined to be a motion image according to the comparison result of the comparator.

15. The liquid crystal display panel of claim 14, wherein each of the frame tables comprises different luminance values, and the luminance of the second frame of the image data is compensated with the frame tables.

16. The liquid crystal display panel of claim 9, wherein the counter comprises a data line counter for counting a current pixel location among the data lines.

17. The liquid crystal display panel of claim 9, wherein when the second frame is determined to be a still image according to the comparison result of the comparator, the luminance of the second frame is compensated with the pixel location of the second frame of the image data and the frame rate control look-up table, reducing luminance non-uniformity due to transmission line signal loss.

18. The liquid crystal display panel of claim 9, wherein the look-up table further comprises an over drive control look-up table for reducing image blurring when the second frame is determined to be a motion image according to the comparison result of the comparator.

19. The liquid crystal display panel of claim 9, wherein each of the frame tables comprises different luminance values, and the luminance of the second frame of the image data is compensated with the frame tables.

20. A method for compensating scan signal loss of a liquid crystal display panel wherein the liquid crystal display comprises a plurality of scan lines, a plurality of data lines, a plurality of pixels each corresponding to one of the data lines and one of the scan lines, a data driver coupled to the data lines, and a scan driver coupled to the scan lines, the method comprising:
comparing a first frame of image data and a second frame of the image data;
providing a pixel location of the second frame of the image data; and
compensating a luminance of the second frame with a frame rate control look-up table according to the comparison result.

21. The method of claim 20, wherein the first frame comprises a previous frame.

22. The method of claim 21, wherein the second frame comprises a current frame.

23. The method of claim 22, wherein a data line counter counts a current location of the data lines as the pixel location of the second frame of the image data.

24. The method of claim 23 wherein when the second frame is determined to be a still image according to the comparison result, the luminance of the second frame is compensated in accordance with the pixel location of the second frame of the image data and the frame rate control look-up table, reducing luminance non-uniformity due to transmission line signal loss.

25. The method of claim 24 wherein the frame rate control look-up table comprises a plurality of frame tables, each comprising different luminance values for luminance compensation of the second frame.

26. The method of claim 20, wherein a data line counter counts a current location of the data lines as the pixel location of the second frame of the image data.

27. The method of claim 20, wherein when the second frame is determined to be a still image according to the comparison result, the luminance of the second frame is compensated in accordance with the pixel location of the second frame of the image data and the frame rate control look-up table, reducing luminance non-uniformity due to transmission line signal loss.

28. The method of claim 20, wherein the frame rate control look-up table comprises a plurality of frame tables, each comprising different luminance value for luminance compensation of the second frame.
